(19) United States
(12) Patent Application Publication
(10) Pub. No.: US 2013/0025839 A1
(43) Pub. Date: Jan. 31, 2013

(54) THERMAL SUBSTRATE

(71) Applicants: Frank Egitto, Binghamton, NY (US); Voya R. Markovich, Endwell, NY (US); Varaprasad V. Calmidi, Binghamton, NY (US); Timothy Antesberger, Vestal, NY (US); William E. Wilson, Waverly, NY (US)

(72) Inventors: Frank Egitto, Binghamton, NY (US); Voya R. Markovich, Endwell, NY (US); Varaprasad V. Calmidi, Binghamton, NY (US); Timothy Antesberger, Vestal, NY (US); William E. Wilson, Waverly, NY (US)

(73) Assignee: ENDICOTT INTERCONNECT TECHNOLOGIES, INC., Endicott, NY (US)

(21) Appl. No.: 13/189,980

(22) Filed: Jul. 25, 2011

(51) Int. Cl. F28F 7/00; B23P 19/04; B23K 26/38; B32B 3/10

(52) U.S. Cl. 165/185; 428/137; 29/428; 219/121.67

(57) ABSTRACT

An organic substrate capable of providing effective heat transfer through its entire thickness by the use of parallel, linear common thermally conductive openings that extend through the substrate, the substrate having thin dielectric layers bonded together to form an integral substrate structure. The structure is adapted for assisting in providing cooling of high temperature electrical components on one side by effectively transferring heat from the components to a cooling structure positioned on an opposing side. Methods of making the substrate are also provided, as is an electrical assembly including the substrate, component and cooling structure.

### FIELD OF THE INVENTION

The invention relates to organic substrates, including circuitized substrates such as printed circuit boards (hereinafter also referred to as PCBs). More particularly, the invention relates to such organic substrates adapted for having one or more high power devices (e.g., semiconductor chips) mounted thereon.

### BACKGROUND OF THE INVENTION

Organic substrates, particularly those used for PCBs, are well known structures and are presently utilized in many different applications such as personal computers, computer servers, etc. Such PCBs typically comprise the fabrication of separate inner-layer circuits (circuitized layers). One means of formation comprises coating a photosensitive layer or film over a copper layer of a copper clad inner-layer base material. The photosensitive coating is imaged, developed, and the exposed copper is etched to form the desired number of conductor lines. The photosensitive film is then stripped from the copper, leaving the circuit pattern on the surface of the inner-layer base material. Often, this methodology is referred to in the art as photolithographic processing with subtractive circuitization.

In addition to the above described means of circuit formation, it is possible (and in some instances preferred) to use a semi-additive plating technique as a patterning process. In one example, a relatively thin (1000 Angstroms to 6000 Angstroms) layer of metal, typically copper, is deposited onto the surface of the substrate to be plated. This metal “seed” layer is commonly applied using sputter deposition and/or a chemical seed and electro-less plating processes. In some instances, a sputter deposited layer comprises two metals, the first of which is used to promote adhesion between the second sputter deposited metal and the substrate. This first sputter deposited metal layer is often referred to as a “tie” layer, and may be chromium or titanium. Photoresist is then applied, exposed, and developed to generate a reverse mask; that is, the mask serves to precisely expose those areas of the substrate that will eventually have the metal traces thereon. Additional metal is then plated onto the substrate in the unmasked areas. The thickness of the metal is less than the thickness of the photoresist mask. Copper is commonly used for the metal component, and subsequent plating steps can be employed to deposit other metals, for example nickel and gold, onto the surface of the copper. After plating, the photoresist is removed, exposing the thin layer of metal on the surface of the substrate. A quick etching step, or flash etch, is used to remove this thin seed layer, isolating the individual circuit features. Since the seed layer is much thinner than the plated features, the latter are not significantly distorted by the flash etch.

Typically, a multilayered stack is formed of these inner layers, following formation of the desired number of inner-layer circuits, by preparing a lay-up of inner layers, ground planes, power planes, etc., typically separated from each other by a layer of dielectric “pre-preg” material, which may include a layer of glass cloth (e.g., fiberglass) impregnated with a partially cured material (e.g., a “B-stage” epoxy resin). The outermost (top and bottom) layers of the stack may comprise copper clad, glass-filled, epoxy planar substrates with the copper cladding comprising exterior surfaces of the stack. This stack is laminated to form a monolithic structure using heat and pressure to fully cure the B-stage resin. This resulting stack thus has metal (usually copper) cladding on both of its exterior surfaces. Exterior circuit layers are formed in the copper cladding using procedures similar to the procedures used to form the inner-layer circuits. In addition, the copper cladding may be completely removed, and a semi-additive plating process can be used to form the exterior circuit layers. Various elements of these outer conductive layers, such as pads, may then be electrically coupled to selected electronic components mounted on the structure, such components including capacitors, resistors, modules, and semiconductor chips.

In such PCBs, conductive thru-holes (or “interconnects,” as often referred to in the industry) are used to electrically connect selected individual circuit layers within the structure to each other and/or to the outer surfaces, these thru-holes passing through all or a portion of the “stack.” Thru-holes are generally formed prior to the formation of circuits on the exterior surfaces by drilling holes through the stack at appropriate locations, such drilling usually accomplished using mechanical drills or lasers. Following several pre-treatment steps, the walls of the holes are typically catalyzed by contact with a plating catalyst and metalized, typically by contact with an electro-less or electrolytic copper plating solution to form conductive pathways between circuit layers. Following formation of the conductive thru-holes, exterior circuits, or outer conductive layers are formed using the above procedure(s). Another means of interconnecting the various circuit layers within, and external to the PCB is using a “build-up” technology whereby “blind vias” (partial depth openings) are drilled through the layer of dielectric to an underlying circuit feature on the opposing side of the dielectric. The blind vias and upper surface of the dielectric are plated simultaneously, with the circuit features being formed as described by one of the methods outlined above (subtractive or semi-additive).

Following the described construction, the aforementioned semiconductor chips and/or other electrical components are mounted at appropriate locations on one or both of the exterior circuit layers of the multilayered structure, typically using solder mount pads and solder ball technology. These components are usually in electrical contact with the circuits within the structure through the conductive thru-holes, as desired. Such solder pads may be defined by applying an organic solder mask coating over the exterior circuit layers. The solder mask may be applied by screen coating a liquid solder mask coating material over the surface of the exterior circuit layers using a screen having openings defining areas where solder mount pads are to be formed. Alternatively, a photo-imageable solder mask may be coated onto the board and then exposed and developed to yield an array of openings defining the pads. The openings are then coated with solder using processes known to the art, one known process being wave soldering.

One major concern with respect to circuitized substrates of the type described above which are adapted for working with electronic components such as semiconductor chips, modules, resistors etc. involves the effective dissipation of heat generated by such components. This has become more of a concern of late due to the increasing temperatures such high power devices, having greater capacities than ever before, are now reaching during operation. With respect to high power (also called high performance) chips, for example, some of these chips are capable of attaining 200 watts and operating at chip junction temperatures of about 85 degrees C. In many of today's substrate designs, as stated above, such components may be mounted on one or both external surfaces of the substrate and electrically coupled to selected internal circuitry, e.g., using plated thru-holes (PTHs). Understandably, if effective cooling of such devices is not accomplished, severe damage and even destruction of the substrate and/or device(s) may occur.

Various cooling approaches for such structures are known. For example, dissipating heat sinks and similar structures have been used, some of these being directly bonded to the chip(s) or thermally coupled through a selected heat transferring medium. Such structures typically consist of projecting elements (e.g., fins) of a sound heat conductive material (e.g., aluminum or copper) which are thermally connected, as stated, either directly or indirectly, to the heat generating components or to a supporting member for same. These projections offer a relatively large surface area exposed to ambient temperatures, across which cooling air may be directed to enhance heat removal. Utilization of heat pipes is also known for maintaining electronic components at suitable working temperatures. A heat pipe typically comprises a span of pipe closed at its ends and partially filled with fluid capable of being heated by the adjacent component, this pipe often comprising at least one evaporation region located close to or in contact with the heat source and at least one condensation region, for example, exposed to air which circulates the product in question. Other approaches are also known, as understood from the following description.

Examples of circuitized substrates and related structures are described in the following U.S. patents. The citation thereof is not an admission that any are prior art to the instantly claimed invention or that an exhaustive search has been completed.

In U.S. Pat. No. 7,849,914, issued Dec. 14, 2010 to DiStefano, et al. and entitled COOLING APPARATUS FOR MICROELECTRONIC DEVICES, there are described various structures for cooling microelectronic devices (semiconductor chips), including those which employ fins, liquid cooling, etc.

In U.S. Pat. No. 7,823,274, issued Nov. 2, 2010 to Egitto, et al. and entitled METHOD OF MAKING MULTILAYERED CIRCUITIZED SUBSTRATE ASSEMBLY, there is described a method of making a multilayered circuitized substrate assembly which includes bonding at least two circuitized substrates each including at least one layer of high temperature dielectric material, one of these layers in turn including at least one thru-hole therein having a quantity of a low temperature conductive paste, the paste including an organic binder component and at least one metallic component. The flakes of the metallic component are sintered during the bonding to form a conductive path through the dielectric of one of the substrates.

In U.S. Pat. No. 7,738,249, issued Jun. 15, 2010 to Chan, et al. and entitled CIRCUITIZED SUBSTRATE WITH INTERNAL COOLING STRUCTURE AND ELECTRICAL ASSEMBLY UTILIZING SAME, there is described an electrical assembly which includes a circuitized substrate including a first plurality of dielectric and electrically conductive circuit layers alternatively oriented in a stacked orientation, a thermal cooling structure bonded to one of the dielectric layers and at least one electrical component mounted on the circuitized substrate. The circuitized substrate includes a plurality of both electrically conductive and thermally conductive thru-holes located therein. This patent is assigned to the same assignee as the present invention.

In U.S. Pat. No. 7,629,684, issued Dec. 8, 2009 to Alcoe, et al. and entitled ADJUSTABLE THICKNESS THERMAL INTERPOSER AND ELECTRONIC PACKAGE UTILIZING SAME, there is described an electronic package which includes a substrate (e.g., a chip carrier substrate or PCB), an electronic device (e.g., a semiconductor chip), a heat sink and a thermal interposer for effectively transferring heat from the chip to the heat sink. The interposer includes a compressible, resilient member (e.g., an elastomeric pad) and a plurality of thin metallic sheets (e.g., copper foils). The thickness thereof can be adjusted by altering the number of such foils.

In U.S. Pat. No. 7,429,789, issued Sep. 30, 2008 to Japp, et al. and entitled FLUOROPOLYMER DIELECTRIC COMPOSITION FOR USE IN CIRCUITIZED SUBSTRATES AND CIRCUITIZED SUBSTRATE INCLUDING SAME, the formation of PCB layers is described as first impregnating a non-woven aramid chopped fiber mat or a thermoplastic liquid crystalline polymer (LCP) paper instead of the reinforcement typically used in the electronics industry. The aramid reinforcement comprises a random (in-plane) oriented mat of p-aramid (poly(p-phenylene terephthalamide) fibers comprising Kevlar. (Kevlar is a registered trademark of E. I. DuPont de Nemours and Company.) The thermoplastic liquid crystal polymer paper is a material called Vecrus. (Vecrus is a registered trademark of Hoechst Celanese Corp.) The LCP paper is further described as having the company's Vectra polymer, Vectra also being a registered trademark of Hoechst Celanese Corp.

In U.S. Pat. No. 7,301,108, issued Nov. 27, 2007 to Egitto, et al. and entitled MULTI-LAYERED INTERCONNECT STRUCTURE USING LIQUID CRYSTALLINE POLYMER DIELECTRIC, there is described a multi-layered interconnect structure and method of formation. In a first embodiment, first and second liquid crystal polymer (LCP) dielectric layers are directly bonded, respectively, to first and second opposing surfaces of a thermally conductive layer, with no extrinsic adhesive material bonding the thermally conductive layer with either the first or second LCP dielectric layer. In a second embodiment, first and second two signal, one power (2S1P) substructures are directly bonded, respectively, to first and second opposing surfaces of a LCP dielectric joining layer, with no extrinsic adhesive material bonding the LCP dielectric joining layer with either the first or second 2S1P substructures.

In U.S. Pat. No. 7,186,590, issued Mar. 6, 2007 to Alcoe, et al. and entitled THERMALLY ENHANCED LID FOR MULTICHIP MODULES, there is described an electronic package having one or more components comprising a substrate having a first coefficient of thermal expansion, a lid attached to the substrate, the lid including a vapor chamber and having a second coefficient of thermal expansion, the first coefficient of thermal expansion matched to the second coefficient of expansion, a thermal transfer medium in contact with a back surface of each component and an outer surface of a lower wall of the lid and each component electrically connected to a top surface of the substrate.

In U.S. Pat. No. 7,035,113, issued Apr. 25, 2006 to Fraley, et al. and entitled MULTI-CHIP ELECTRONIC PACKAGE HAVING LAMINATE CARRIER AND METHOD OF MAKING SAME, there is described a multi-chip electronic package which utilizes an organic, laminate substrate having a plurality of semiconductor chips positioned on an upper surface. The substrate is comprised of a plurality of conductive planes and dielectric layers and couples the chips to underlying conductors on the bottom surface thereof.

In U.S. Pat. No. 6,905,589, issued Jun. 14, 2005 to Egitto, et al. and entitled CIRCUITIZED SUBSTRATE AND METHOD OF MAKING SAME, there is described a method of making a circuitized substrate in which a common layer is used to form multiple, substantially vertically aligned conductive openings in a multilayered component such as a laminate interposer for coupling a chip to a printed circuit board or the like.

In U.S. Pat. No. 6,631,078, issued Oct. 7, 2003 to Alcoe, et al. and entitled ELECTRONIC PACKAGE WITH THERMALLY CONDUCTIVE STANDOFF, a heat dissipating flexible or resilient standoff is mechanically clamped between an electronic module and PCB. The clamping arrangement comprises a heat sink compressing a thermally conductive flexible interface pad over the upper surface of the electronic module by way of mechanical linkage to the PCB.

In U.S. Pat. No. 6,274,242, issued Aug. 14, 2001 to Onodera, et al. and entitled LIQUID CRYSTAL POLYMER FILM, LAMINATE, METHOD OF MAKING THEM AND MULTI-LAYERED PARTS-MOUNTED CIRCUIT BOARD, there is described a method of making LCP films which includes thermotropic liquid crystal polyester and thermotropic liquid crystal polyester amide. Such LCP films are prepared from four classes of compounds.

As defined here-in-below, the present invention provides a new and unique use of an organic substrate as an effective thermal carrier through which much of the heat generated from one or more hot operating devices (e.g., high power chips) is passed to a cooling structure without damage to the organic substrate, particularly the thin dielectric layers which form this substrate. Therefore, the substrate is able to assure effective heat escape from the devices while providing a suitable platform on which the devices are positioned. In one embodiment, the organic substrate may further include circuitry as part thereof to thus assure connections between the components and associated circuitry (e.g., that of a hosting PCB or the like). It is believed that such a substrate having these capabilities represents a significant advancement in the art, as do methods of making same.

### SUMMARY OF THE INVENTION

It is, therefore, a primary object of this invention to enhance the art of organic substrates, including those of the circuitized type.

It is a more particular object of this invention to provide a new organic substrate as defined herein with enhanced heat transference capabilities.

It is another object of this invention to provide a new method of making such substrates.

According to one embodiment of this invention, there is provided an organic substrate comprising a plurality of thin dielectric layers bonded together to form an integral substrate structure having first and second opposing sides, each of these thin dielectric layers including a plurality of openings therein, each of the openings of the plurality of thin dielectric layers being aligned relative to one another to define a plurality of common, parallel linear openings extending substantially entirely through the integral substrate structure from the opposing side to the second opposing side, and a quantity of electrically and thermally conductive material within each of the common, parallel linear openings. The quantities of electrically and thermally conductive material within each of the common, parallel linear openings extend substantially entirely through the integral substrate structure from the first opposing side to the second opposing side, the integral substrate structure being adapted for having at least one electrical component positioned on the first opposing side and a cooling structure positioned on the second opposing side. The quantities of electrically and thermally conductive material within the common, parallel linear openings providing a plurality of heat paths through the substrate structure from the electrical component to the cooling structure to thereby assist in providing effective cooling of the electrical component during operation thereof without damaging the thin dielectric layers which form the substrate.

According to another embodiment of this invention, there is defined a method of making an organic substrate comprising providing a plurality of thin dielectric layers, forming a plurality of openings within each of these thin dielectric layers, aligning the plurality of thin dielectric layers relative to one another such that the openings of each thin dielectric layer align relative to one another, bonding the plurality of thin dielectric layers together to form an integral substrate structure having first and second opposing sides wherein the openings of the pluralities of openings define a plurality of common, linear parallel openings extending substantially entirely through the integral substrate structure from the first side to the second side, and positioning a quantity of electrically and thermally conductive material within each of the common, parallel linear openings such that the quantities of electrically and thermally conductive material within the common, parallel linear openings extend substantially entirely through the integral substrate structure from the first side to the second side. The integral substrate structure is adapted for having at least one electrical component positioned on the first opposing side and a cooling structure positioned on the second opposing side, such that the quantities of electrically and thermally conductive material within the common, parallel linear openings provide a plurality of heat paths through the substrate structure from the electrical component to the cooling structure to thereby assist in providing effective cooling of the electrical component during operation thereof without damaging the thin substrate layers.

According to still another embodiment of the invention, there is provided an electrical assembly comprising an organic substrate including a plurality of thin dielectric layers bonded together to form an integral substrate structure having first and second opposing sides, each of these thin dielectric layers including a plurality of openings therein, the openings in the thin dielectric layer further having a quantity of electrically and thermally conductive material within each of the openings, each of the pluralities of openings being aligned relative to one another to define a plurality of common, parallel linear openings extending substantially entirely through the integral substrate structure from the first side to the second side substantially entirely through the integral substrate structure from the first opposing side to the second opposing side. Further, the assembly includes at least one electrical component positioned on the first opposing side of the organic substrate relative to the common, linear openings and a cooling structure positioned on the second opposing side of the organic substrate relative to the common, linear openings, the quantities of electrically and thermally conductive material providing a plurality of heat paths through the integral substrate structure from the electrical component to the cooling structure to thereby assist in providing effective cooling of the electrical component during operation thereof.

According to yet another embodiment of the invention, there is provided a method of making an organic substrate comprising providing a first thin dielectric layer, forming a plurality of openings within this first thin dielectric layer, positioning a quantity of thermally conductive material within each of the openings within the first thin dielectric layer, aligning second and third thin dielectric layers on opposite sides of the first thin dielectric layer, bonding these first, second and third thin dielectric layers together to form an integral substrate structure, forming a plurality of openings within the second and third thin dielectric layers relative to those within the first thin dielectric layer to define a plurality of common, linear parallel openings extending substantially entirely through the integral substrate structure, and positioning a quantity of thermally conductive material within each of the openings within the second and third dielectric layers such that the quantities of thermally conductive material within each of the openings within the three thin dielectric layers extend substantially entirely through the integral substrate structure. The integral substrate structure is adapted for having at least one electrical component positioned on the second thin dielectric layer and a cooling structure positioned on the third thin dielectric layer, the quantities of thermally conductive material within the openings of the three dielectric layers providing a plurality of heat paths but not electrical paths through the integral substrate structure from the electrical component to the cooling structure to assist in providing effective cooling of the electrical component during operation thereof.

### BRIEF DESCRIPTION OF THE DRAWINGS

A complete understanding of the present invention may be obtained by reference to the accompanying drawings, when considered in conjunction with the subsequent detailed description, in which:

FIG. 1 is a side elevational view showing the alignment of four thin dielectric layers which will eventually become part of an organic substrate according to one embodiment of the invention, the method shown in FIGS. 1-3 using these thin dielectric layers in this manner representing one embodiment of a method of making the substrate;

FIGS. 2 and 3 are partial side elevational views, in section and on an enlarged scale over the view of FIG. 1, illustrating the dielectric layers of the FIG. 1 embodiment bonded together and including two of the common, linear parallel openings therein, these FIGURES showing two different embodiments of such openings;

FIG. 4 is a partial side elevational view, in section and on an enlarged scale over the views of FIGS. 2 and 3, illustrating another embodiment of the organic substrate of the invention;

FIGS. 5 and 6 are partial side elevational views, in section and on approximately the same scale as FIG. 4, illustrating two embodiments of electrical assemblies including an organic substrate of the invention thermally connecting at least one (only one shown, but several being possible) electrical component on one side to a cooling structure on the other side of the substrate;

FIGS. 7 through 9 are side elevational views, in section and on approximately the same scale as FIGS. 2 and 3, illustrating an alternative method of making an organic substrate having the enhanced thermal properties taught herein, this method involving the formation of “blind vias” (partial depth openings) in addition to utilizing some of the processing defined for the embodiments in the preceding FIGURES; and

FIG. 10 is a side elevational view, in section and on a scale approximately the same as FIGS. 7 through 9, illustrating an embodiment of an electrical assembly also including an organic substrate of the invention which has been formed using the steps shown in FIGS. 7 through 9, this substrate thermally connecting at least one (only one shown) electrical component on one side to a cooling structure on the other side of the substrate, thus forming an electrical assembly.

### DESCRIPTION OF THE PREFERRED EMBODIMENT

For a better understanding of the present invention, together with other and further objects, advantages and capabilities thereof, reference is made to the following disclosure and appended claims in connection with the above-described drawings. It is understood that like numerals will be used to indicate like elements from drawing figure to drawing figure.

The following terms will be used herein and are understood to have the meanings associated therewith.

By the term “dielectric layer” as used herein is meant a layer of organic material through which conduction of electric current does not take place or is, at best, negligible. Examples of organic dielectric materials suitable for use in the organic substrate structures of this invention include fiberglass-reinforced or non-reinforced epoxy resins (sometimes referred to simply as “FR-4” material, meaning its Flame Retardant rating), poly-tetrafluoroethylene (Teflon), polyimides, polyamides, cyanate resins, photoimageable materials, and other like materials, including combinations thereof. One preferred material for use in this invention is liquid crystalline polymer (hereinafter also LCP).

By the term “electrical component” as used herein is meant components such as semiconductor chips (including high power chips), modules (e.g., multi-chip modules), resistors, capacitors and the like, which are typically adapted for being positioned on and electrically coupled to the external conductors of circuitized substrates, electrically coupled to other such components (if utilized), and which generate heat at relatively high temperatures.

By the term “metal” as used herein is meant to define the thermally conductive mediums used within the thermally conductive openings of this invention is meant metal and metal alloys such as copper, aluminum or alloys thereof, as well as conductive pastes including metal particles as part thereof. Examples are cited below.

By the term “relatively high temperatures” as used herein is meant to define the heat generated by electrical components is meant temperatures within the range of from about seventy degrees Celsius (C) to about 150 degrees C., prior to cooling thereof. When using the teachings herein (the components are being cooled), these components generate heat from about forty degrees C. to about sixty degrees C. It is thus understood that the invention is capable of significantly reducing the operating temperatures of such high temperature components, thereby extending the life thereof as well as that of the electrical assembly utilizing same.

By the term “thick conductive layer” as used herein is meant a thermally conductive layer (including individual pads and lines) having a thickness within the range of from about 0.5 mils (a mil being 1/1000 of an inch) to about five mils. If such layers are of metal, understandably these are also capable of conductive electrical current.

By the term “thin dielectric layer” as used herein is meant to define the dielectric layers used in this invention is meant a dielectric layer having a thickness within the range of from only about one mil to about ten mils.

By the term “thin organic substrate” as used herein is meant a thickness of the organic substrate formed herein and including the parallel, linear heat paths therein within the range of from about five mils to about nine mils. It is understood that any such formed substrate, comprising of a plurality of thin dielectric layers, includes dielectric layers having accommodating thicknesses from the range cited above to meet this relatively thin final substrate thickness.

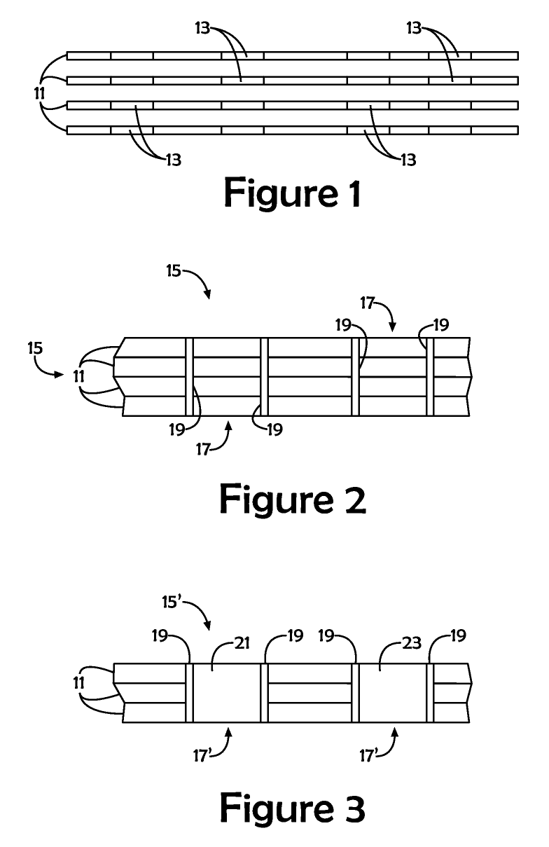

FIG. 1 represents a first step in one embodiment of a method of making an organic substrate of the invention. As shown, four thin dielectric layers 11 are aligned relative to each other in a substantially vertical orientation. In the embodiment of FIG. 1, each layer 11 includes a plurality of openings 13 therein. Each layer 11 includes four such openings 13, and the layers are oriented such that the openings in turn are vertically aligned. Although four layers 11 and four openings 13 are shown, the invention is not limited as these numbers may vary depending on the operational characteristics of the final product utilizing the invention. In one example, each thin dielectric layer 11 may have a thickness of only about two mils (0.002 inch), and each opening 13 may in turn have a diameter of only about one mil (0.001 inch). This thickness to diameter ratio is not limiting of the invention as different thicknesses may be utilized with different diameters. Depending on certain factors, including the thermally conductive medium used, the openings of these thin dielectric layers may have diameters within the range of from about the stated one mil to as wide as about eighteen mils, including combinations of such diameters within the same layer as well as different diameters from layer to layer.

In the FIG. 1 embodiment, openings 13 are preferably cylindrical in shape, and may be formed within the respective layers using mechanical or laser drilling, both of which processes are known in the art for forming substrate openings. Should laser drilling be used, a UV (ultra-violet) laser (e.g., a frequency-tripled Nd:YAG laser operating at a wavelength of about 355 nanometers) may be used. Other lasers which may be used include excimer, Nd:YLF, Nd:YAP and Nd:YD04 lasers. In an alternative embodiment, the four dielectric layers, sans openings, may be bonded (e.g., laminated) together and the common openings formed to extend through this bonded, integral structure, as do the individually formed openings of the layers prior to the aligned bonding. Such formation may be accomplished using the described mechanical or laser drilling operations.

A preferred dielectric material for layers 11 is liquid crystalline polymer (LCP), which has many positive attributes for forming dielectric layers, including low cost and good mechanical and dielectric properties. LCP dielectric materials have some characteristics similar to those of polyimides, such as good tear resistance and good stretching resistance, which make LCP dielectric materials suitable for processing (e.g., cicuitization, plating, etc.). LCP films, depending on composition, may offer advantages over polyimide films such as better electrical properties, better moisture resistance and better dimensional stability. In addition, LCP dielectric films are flame retardant without the use of halogen-based additives. One LCP dielectric material that may be used in the present invention is a commercially available LCP dielectric material sold under the product name Zyvex LCP thermotropic liquid crystal polymer, manufactured in roll form by the Rogers Corporation, and sold as the Ultralam 3000 family of LCP materials. (Zyvex is a trademark of Zyvex Instruments, which also provides this material.) Generally, any LCP dielectric material is potentially usable with the present invention, depending on the properties desired in a given application. Other dielectric materials such as the aforementioned polyimides, may also be used in this invention.

With the present invention, if LCP dielectric material is used, it may be laminated to an adjacent surface of a layer of material (e.g., copper) through elevation of temperature within the material's liquid crystal temperature domain, and under sufficient pressurization to induce plastic deformation and consequent adhesion to the adjacent surface, while preserving its macroscopic material properties. This process of plastic adhesion does not require the presence of an extrinsic adhesive layer to bond the LCP dielectric material to the adjacent layer. Bonding of the LCP dielectric material may be necessary if it is desired in the present invention to also include such metal layers, in thick form, as part of the final organic substrate. Further description of such an alternative is provided below.

Bonding of the four thin dielectric layers 11 is preferably accomplished using lamination, a process known in conventional PCB manufacturing. In one example, the four layers 11 shown in FIG. 1 (where layers 11 are LCP dielectric) may be laminated at a temperature within the range of about 275 degrees Celsius (C) to about 290 degrees C., at a pressure within the range of from about 200 pounds per square inch (PSI) to about 400 PSI, and for a time period of from about 180 minutes to about 300 minutes. In a more specific example, layers 11 may be laminated at 275 degrees C., 300 PSI, for 240 minutes.

Significantly, the resulting integral structure 15, partly seen in FIG. 2, is thin, meaning that it may possess an overall thickness of only about five mils to about eight mils when so compressed, a reduction of about ten percent from the combined initial thicknesses of the layers prior to compression. Similar reductions are attained for structures of more or less layers. It is also within the scope of this invention to bond the respective layers 11 using a suitable adhesive, several of which are known in the art and further description is not deemed necessary. As a result of the bonded thin layers each having openings 13 therein, a plurality of common, linear and parallel openings 17 is formed. In the FIG. 1 through 3 embodiment, each common opening 17 has a similar diameter as the corresponding individual diameters of the respective individual openings 13 aligned to form the common opening. It is understood, however, that the plurality (in this example, four) of openings 13 may have different diameters. That is, the openings 13 used to form the common openings of this invention may possess a combination of different diameters. One additional example of such an embodiment is defined with the description of FIGS. 7 through 10.

As stated, a key function of the integral organic substrate structure, when completed, is to provide effective heat transference there through so as to enable adequate cooling of one or more electrical components positioned on the structure. To accomplish this, each of the common openings 17 (FIG. 2) formed from the defined bonding of layers 11 includes a quantity of sound heat conducting metal therein.

In one embodiment, this metal, shown by the numeral 19 in FIG. 2, is plated onto the dielectric sidewalls of the formed common openings and thus extends through the entire thickness of integral substrate structure 15 from its upper side or surface to its lower side or surface.

In one example, metal 19 is copper (another preferred metal being aluminum) and plated onto the sidewalls using electroplating. Either electrolytic or electro-less plating may be used for this plating operation. Further, layer of metal 19 may include, inter alia, nickel. In a more specific example, not limiting of this invention, the electroplating may use phosphorized copper anodes, may occur under a current density of about 15 amps per square foot (of the sidewall surface) to about 25 amps per square foot, and may use an acid copper bath. The acid copper bath in turn may include such components as sulfuric acid having a concentration between about 150 grams/liter to about 250 grams/liter, a chloride having a concentration between about 30 ppm and about 100 ppm, a copper ion concentration between about 15 grams/liter and about 25 grams/liter, and an organic additive. Vigorous agitation of the acid copper bath may be employed to better wet the dielectric sidewall surfaces being electroplated. Prior to this electroplating example, sidewalls 13 may be wetted, such as with ammonium hydroxide, to facilitate good contact between the metal and these sidewalls.

Briefly, the metal 19 should be as thick as possible and, preferably, substantially fill each of the common aligned openings 17. In the embodiment of FIG. 2, each opening is only partly filled, the resulting thickness of each plated layer being from about 0.5 mils to about nine mils, depending on the diameter of openings 17. In comparison, the common openings 17′ of FIG. 3 are entirely filled with metal, from the top side of the structure to the underside. (The substrate 15′ is shown to include only three dielectric layers 11 for ease of illustration purposes.) In the opening 17′ to the left in FIG. 3, the plated metal is supplemented with additional interior metal 21 (e.g., copper or copper alloy) and may be added using further plating conducted in a similar manner as the plating processing defined above.

In the opening 17′ to the right in FIG. 3, the supplemental conductive material 23 may comprise conductive paste or similar conductive medium other than plated metallurgy. Examples of an electrically conductive paste usable with the invention must be bondable (capable of lamination) if lamination is used to compress the dielectric layers. Typical examples of bondable electrically conductive materials are conductive pastes such as silver filled epoxy paste obtained from E.I. DuPont deNemours & Company under the trade designation CB-100, Ablebond 8175 from the Ablestik Company, or other metal particles such as gold, tin, palladium, copper, alloys, and combinations thereof. One particular example is coated copper paste. Metal coated polymeric particles disposed in a polymeric matrix may also be used. Further, metal particles having an oxide nano surface coating may be used. Examples of such metals adapted for having such oxide coatings include gold, silver, aluminum, palladium, platinum, rhodium, and combinations or mixtures thereof. Examples of such oxides include silica, doped silica, silica-based composites, titania, doped titania, titania-based composites, alumina, doped alumina, alumina-based composites, zinc oxide, doped zinc oxide, zinc oxide-based composites, and combinations or mixtures thereof. The invention is not limited to these specific examples.

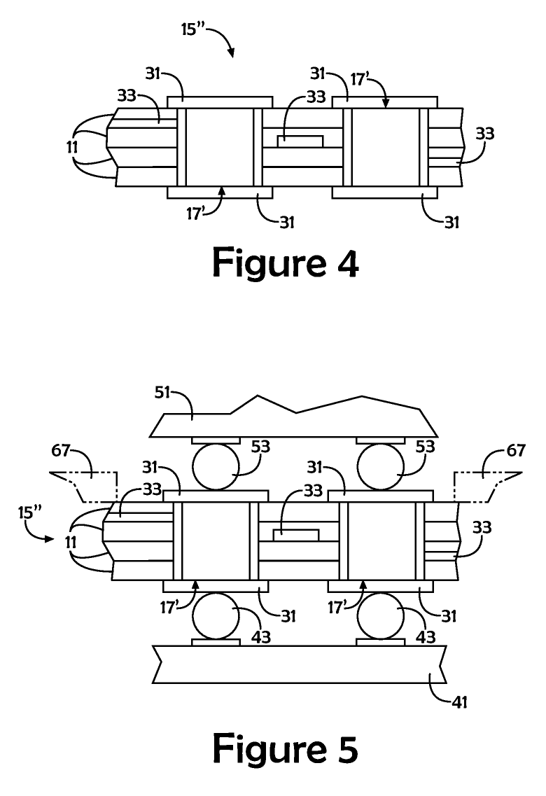

In FIG. 4, there is shown a partial side view of an organic substrate 15″ according to one embodiment of the invention. Substrate 15″ includes the above four dielectric layers 11 bonded together, in addition to the aligned common, parallel linear openings 17′. Openings 17′ are filled with metal, as defined above, and further include a thick, thermally conductive pad 31 on opposite ends thereof. Pads 31 are metal (e.g., copper or aluminum or of an alloy thereof) and in one embodiment may have a thickness of 0.5 mil, these pads in turn being part of a thick conductive layer. In addition, substrate 15″ may also include one or more thick thermally conductive elements 33 such as a circuit line (as shown) as part of the structure, this line also being part of a thick circuit layer for substrate 15.″ Pads and other elements of these layered structures are thick and, as seen in FIG. 4, may be thermally coupled to one or more of the metal of common thermally conductive openings 17′ (two being shown in FIG. 4) or be slightly separated therefrom as illustrated by the sole element 33 shown substantially in the center portion of substrate 15″. Regardless of positioning, such pads or circuit lines are capable of conducting both heat and electrical current in the final substrate, if desired. For example, one or more conductors of the electrical component (defined below) may be electrically connected to one or more of these thermally conductive members which in turn may be electrically connected to other circuitry (not shown) such as a ground or power layer, including those on a hosting, larger PCB on which the organic substrate and its associated components are positioned. Therefore, the organic substrate may provide effective thermal transference but may also function as a circuitized substrate should such an added feature be required.

The illustrated thermally conductive members 33 may be formed using a conventional photolithographic process when forming the substrate. For example, one or more members, including lines and pads, may be formed onto a respective one of the thin dielectric layers prior to bonding thereof with other dielectric layers in the manner defined above. Such formation may be accomplished using photolithographic processing, as mentioned above, but by other means known in the substrate art. Further description is thus not deemed necessary. The only requirement for such members is that these be of the thicknesses defined, to assure effective heat transference. In the FIG. 4 embodiment, it is understood that members 33 shown coupled to one of the respective common openings (two are shown) serve to pass heat therealong when heat is transferred through the opening. These members 33 may in turn extend to the periphery of the organic substrate. Similarly, the internally positioned member (line 33) shown in the center of FIG. 4 may also extend toward or away from the viewer to the substrate's periphery, as well to other circuitry, not shown. It is not necessary for purposes of this invention that a thermal pad or other member be in direct thermal contact with one of the respective common openings to provide additional thermal transfer, since added heat transference is possible due to the use of thin dielectric layers, as taught.

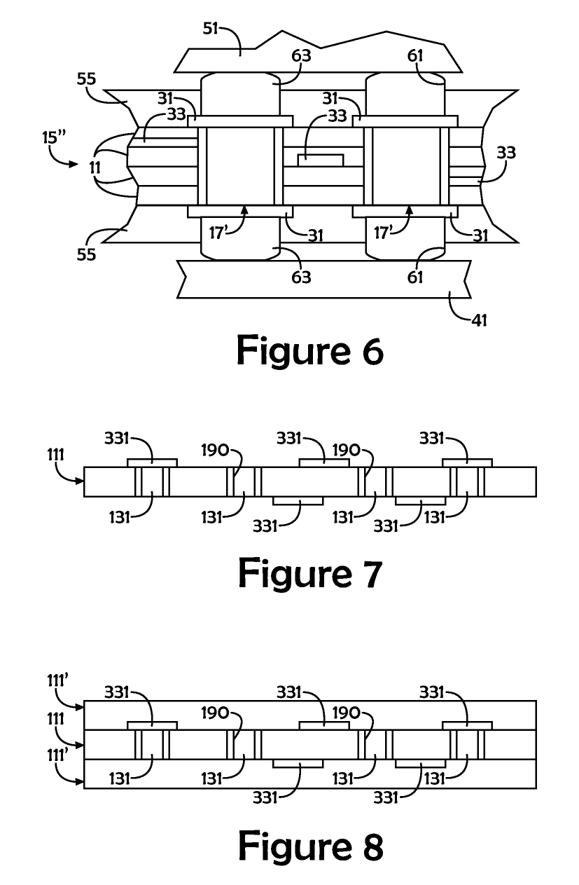

FIGS. 5 and 6 depict two embodiments of electrical assemblies which utilize organic substrates of this invention capable of providing effective heat transference for electrical components which form part of these assemblies. In FIG. 5, an electrical component 41 is shown positioned on the underside (bottom surface) of organic substrate 15″ which in turn includes the features of the substrate of FIG. 4. One example of an electrical component that operates at relatively high temperatures (produces excessive heat) is a high power (performance) chip, many of which are in use today. Such chips, including a housing as shown, produce great amounts of heat at elevated temperatures during normal operation and must therefore be adequately cooled to prevent damage thereto or destruction thereof. It is understood that while only one such chip is shown, more components operating at relatively high temperatures may also be positioned on the underside of the substrate, while achieving the necessary heat transference. The invention is thus capable of providing effective cooling of several such components.

In the specific FIG. 5 embodiment, heat generated from the chip(s) 41 is initially passed through a thermal coupling means such as a plurality of solder balls 43 positioned on the chip's illustrated housing to the substrate's lower conductive pads 31. Understandably, it is not necessary to use solder balls as the chip's housing's exterior surface could instead be directly bonded to pads 31 by other means, such as by a suitable electrically conductive adhesive, which is an alternative thermal coupling means.

If solder is used, its melting point temperature is of course greater than the temperature reached by the chip(s) 41 being cooled. One example of a solder composition able to provide this is 90:10 tin:lead solder, a composition used by various component manufacturers to bond the components to circuituized substrates such as PCBs. Each ball may in turn have a diameter of about 35 mils. Significantly, the chip's exterior body surface (and not its individual contact sites, not shown) is directly coupled to the thermal coupling solder balls. In comparison, the chip's electrically conductive sites are in turn electrically coupled, including by other solder balls or wire-bonds, to other circuit elements (also not shown). That is, the invention provides cooling for the chip's body for enhanced thermal transfer and physical contact with the component's body is needed to accomplish this.

It should be added that while heat from the component(s) housing (body) is being directly transferred to the solder balls and then through the common parallel, linear heat paths within the substrate, heat transfer is further enhanced if the component is electrically coupled to the substrate's external pads (not shown) using solder balls such as those described herein. That is, additional heat transfer is achieved when heat from the component(s) also passes through the component's conductive sites (typically metal) and into solder balls which in turn are mounted on and coupled to the external metal pads, the heat being so passed then able to escape into the ambient.

With particular attention to heat transference through the substrate's linear, parallel openings, the heat from the chip housing is passed from the thermal coupling means up through these openings 17′ (and out through conductive metal pad members 33, if used on the substrate) to a cooling structure 51 positioned on the top side of the organic substrate, preferably again using a plurality of thermal coupling solder balls 53 (which may or may not be of the same solder composition as solder balls 43). Solder balls 53 are also defined as thermal coupling means when used in this manner. As with the connections of chip(s) 41, however, use of solder ball thermal couplers is not required for the present invention as cooling structure 51 could instead be directly physically coupled to pads 31 using a suitable adhesive. Cooling structure 51 may be one of many different types of such structures, including those having heat-sinking fins (e.g., aluminum or copper), pipes for having heated fluid pass therethrough, etc. Some of these structures are described above and also further described in the above listed U.S. Pat. No. 7,849,914. Further description is not deemed necessary.

The embodiment of FIG. 6 is substantially similar to that of FIG. 5 with one exception being the use of conventional solder mask material 55 applied in layer form onto the respective opposing sides of substrate 15″. The layer of solder mask material may be applied by screen coating a liquid mask coating material over the exterior surfaces of the organic substrate seen in FIG. 4 using a screen having openings therein to accommodate the respective thick conductive pads 31. Alternatively, a photo-imageable layer of solder mask material may be coated onto the exterior surfaces and exposed and developed to yield an array of openings defining the pads. This form of processing is also described above in greater detail.

One example of an organic solder mask material usable in the invention is what is referred to in the industry as Advanced Solder Mask (ASM). The ASM material includes an epoxy resin system including between about 10% and about 80% by weight of a polyol resin (which is a condensation product of epichlorohydrin and bisphenol A having a molecular weight of between about 40,000 and 130,000), between about 20% and about 90% by weight of an epoxidized octafunctional bisphenol A formaldehyde novolak resin having a molecular weight of 4,000 to 10,000, and between about 35% and 50% by weight of an epoxidized glycidyl ether of tetrabromo bisphenol A having a melting point of between about 90 degrees C. and about 110 degrees C. and a molecular weight of between about 600 and 2,500 if flame resistant properties are required. To this resin system is added about 0.1 to about 15 parts by weight per 100 parts of resin of a cationic photoinitiator capable of initiating polymerization of said epoxidized resin system upon exposure to actinic radiation. Another example of such a liquid solder mask material usable for this invention is sold under the product name PSR 4000 BN and is available from Taiyo, Inc. The invention is not limited to these particular compositions, and further description is not considered necessary.

As seen in FIG. 6, the layer of solder mask includes openings 61 therein in which are positioned quantities of thermal coupling means, these being solder 63. The sidewalls of openings 61 maintain the solder 63 in what might be referred to as an upright orientation whereby substantially flat or planar exterior surfaces of the solder engage the corresponding flat or planar surfaces of the electrical component and cooling structure to thereby assure maximum physical (and thus thermal) surface area engagement between these elements. The solder compositions for solder 63 may be similar to that of solder balls 43 and 53, or of another composition with a melting point in excess of the high temperatures generated from component(s) 41. The selected solder mask material also possesses a similar thermal property.

In FIG. 7, there is shown an initial step in making an organic substrate according to another embodiment of the invention. Specifically, a single thin dielectric layer 111 is provided with openings 131 formed therein, similarly to the individual layers 11 (and openings 13) in FIG. 1. A layer of similar dielectric material, thicknesses and openings as layers 11 may be used. On opposite sides of layer 11 are formed thick conductors 331, some of which (explained below) may form part of a thick conductive layer which functions also a part of the substrate's circuitry, the other parts of such circuitry not shown for ease of explanation. Formation of conductors 331, like those of conductors 33, may be accomplished using photolithographic processing as well as by other means known in the substrate art. Of significance, two (top right and top left) of the conductors 331 are formed over (across) a respective one of the openings 131. This may be achieved by initially forming the individual conductors on the dielectric layer and thereafter forming a blind via, in this case the two openings 131 (to the far left and far right) in FIG. 7. As with the openings in the embodiments above, openings 131 may be of similar diameter or a combination of different diameters, and formed using laser or mechanical drilling. Should laser drilling be used, the above defined UV (ultra-violet) laser (e.g., a frequency-tripled Nd:YAG laser operating at a wavelength of about 355 nanometers) may be used.

At this point, the openings 131 are plated with metal layers 190, preferably of copper or aluminum, using one of the above mentioned plating technologies. Plating these openings is considered necessary to prevent the possible collapse of the opening sidewalls during the following lamination step. It should be added at this point that it is also possible to add thermally conductive material (not shown in FIGS. 7 through 9) within one or more of the outer pairs of openings having plating thereon. If so added, one of the above cited materials such as silver filled epoxy paste obtained from E.I. DuPont deNemours & Company under the trade designation CB-100, Ablebond 8175 from the Ablestik Company, or other metal particles such as gold, tin, palladium, copper, alloys, and combinations thereof may be utilized.

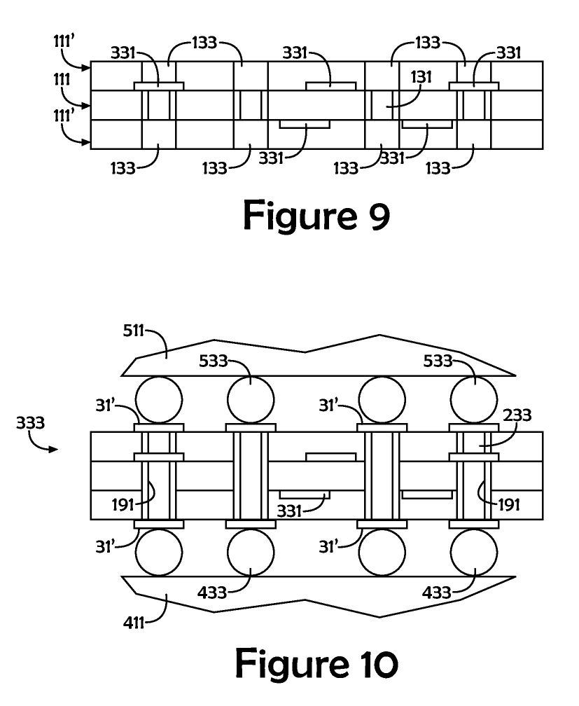

In FIG. 8, two outer thin dielectric layers 111′ and 111″ are bonded (e.g., laminated) to opposing sides of the now interim layer 111, these outer layers preferably of similar thickness and material as layer 111. Unlike layers 11 in FIG. 1, however, the outer layers in this particular embodiment do not include openings therein at this stage, unlike the described interim layer 111 already having plated openings therein. Formation of openings 133 within these outer layers 111′ and 111″ is shown in FIG. 9, such formation achieved, as with the openings in the interim layer, using mechanical or laser drilling. Should laser drilling be used, again, the above defined UV (ultra-violet) laser (e.g., a frequency-tripled Nd:YAG laser operating at a wavelength of about 355 nanometers) may be used. Openings 133 are preferably cylindrical in shape, as are openings 131. The pairs of openings 133 to the right and left in FIG. 9 are the aforementioned blind via openings, meaning that the opening was formed from the respective sides of the substrate to a depth where it reached a respective pad 331. Therefore, the pad serves to define the final depth of each of these blind openings. In comparison, the openings in the centermost part of the substrate in FIG. 9 are formed with the previously plated interim openings in place. This formation is likewise accomplished from opposite sides of the substrate but there is no pad to determine the final opening depth.

In the FIG. 9 embodiment, it is significant to note that the pads 331 which extend within the now formed common, linear and parallel openings otherwise extending through the substrate (to the right and left), are thick and of a sound thermally conductive metal such that these assist in heat transference through the openings. That is, the heat from the component positioned on the substrate passes into these two openings, into and through these protruding thermally conductive pads, and then through the remainder of the respective opening, to the cooling structure. This arrangement is shown in greater detail in FIG. 10. The presence of these protruding pads does not adversely affect the effective heat transfer through the common openings including same, providing yet another versatile feature for this invention. Finally, each of the outer openings 133 in the FIG. 9 embodiment are plated, preferably using metallurgy and processing similar to that used to plate openings 131 in FIG. 7. This plating is not shown in FIG. 9 for ease of illustration but is shown in FIG. 10, as is the earlier plating of the interim layer openings.

In FIG. 10, there is shown an electrical assembly 333 according to one embodiment of the invention, this assembly utilizing the integral substrate formed in the steps shown in FIGS. 7 through 9. Assembly 333 may include one or more of the features, i.e., external pads 31′, solder mask (not shown), and/or a stiffener or similar supporting member (not seen in FIG. 10 but partially shown in phantom in FIG. 5 and represented by numeral 67), as the assemblies shown in FIGS. 5 and 6. Like the assembly in FIG. 5, assembly 333 utilizes solder balls 433 and 533 to provide thermal coupling between the housings of the assembly's heat generating component(s) 411 and cooling structure 511. Such couplings may also be achieved using the thermal coupling solder and solder mask features of FIG. 6.

Significantly, the parallel, linear openings (four shown in FIG. 10) include a combination of plated openings (shown by plating metal 191) and openings containing conductive paste 233. It is possible, as shown, to use different such openings (paste and plated) to form one of the linear, parallel openings, and still attain the unique enhanced heat transference taught herein. The various combinations shown in FIG. 10 are only representative of many such combinations, including when more than three thin dielectric layers are used to form the final substrate.

In addition to the above features, the assemblies shown in FIGS. 5, 6 and 10 are also electrical in nature (have one or more internal and/or external circuits) in order for the electrical components (and other components if used) to function. Therefore, the defined common, parallel linear openings which provide effective heat transfer may also function as electrical connections between contact sites (not shown) of such components and selected parts of the substrate's illustrated electrically conductive elements such as pads 33. Components such as semiconductor chips are known to include pluralities of electrical contact sites on a lower surface thereof and it is also known to electrically couple such electrically contact sites to corresponding conductors such as contact pads on a hosting substrate using such connecting elements as wire-bond wires and solder balls. Such electrical couplings are not shown herein for ease of illustration and explanation and especially because such electrical connections are well known to those skilled in the circuitized substrate art.

Thus there have been shown and described a new organic substrate capable of assuring effective heat transference from one or more high temperature operating electrical components positioned thereon to a cooling structure located on an opposing side thereof. The substrate may be formed using primarily conventional substrate manufacturing processes known in the art and thereby assure relatively low costs for the final product. The formed organic substrate, of relatively overall thin construction, is uniquely capable of effectively cooling a plurality of such heat generating devices, in addition to providing a sufficient platform on which these components are positioned, without being damaged when excessive heat transfer is provided. Because of this relatively thin construction, it may also be desirable to utilize a metal (e.g., stainless steel or aluminum) stiffener 67 or like supporting member, as partially shown in phantom in FIG. 5. Being metallic, such an added structure further enhances heat transference provided heat is properly directed to the body thereof. Understandably, the invention is able to provide such direction through the use of common, linear and parallel heat transfer openings, including those over which such a metal member may be oriented and thermally connecting these openings to thermal coupling means associated with the housings of the electrical components. Stiffeners and the like supporting structures are known in the art, primarily for use with flexible circuits, and further description is not considered necessary.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An organic substrate comprising:
a plurality of thin dielectric layers bonded together to form an integral substrate structure having first and second opposing sides, each of said thin dielectric layers including a plurality of openings therein, each of said pluralities of openings being aligned relative to one another to define a plurality of common, parallel linear openings extending substantially entirely through said integral substrate structure from said first opposing side to said second opposing side; and
a quantity of thermally conductive material within each of said common, parallel linear openings, said quantity of thermally conductive material extending substantially entirely through said integral substrate structure from said first opposing side to said second opposing side, said integral substrate structure adapted for having at least one electrical component having a housing with thermal coupling means thereon positioned on said first opposing side, and a cooling structure positioned on said second opposing side, said quantity of thermally conductive material providing a plurality of heat paths but not electrical paths through said integral substrate structure from said thermal coupling means on said housing of said at least one electrical component to said cooling structure to assist in providing effective cooling of said at least one electrical component during operation thereof.

2. The organic substrate of claim 1, wherein selected ones of said plurality of thin dielectric layers comprise liquid crystalline polymer dielectric material.

3. The organic substrate of claim 1, wherein said quantity of thermally conductive material comprises at least one layer of metal.

4. The organic substrate of claim 3, wherein said metal comprises copper or aluminum or alloys thereof.

5. The organic substrate of claim 3, wherein said quantity of thermally conductive material within other selected ones of said common, linear openings than said selected ones of said common, linear openings comprises conductive paste, said conductive paste substantially filling said other selected ones of said common, linear openings.

6. The organic substrate of claim 1, further including at least one thermally conductive metal member positioned on one of said thin dielectric layers and extending within one of said openings, said metal member being part of said thermally conductive material within said one of said thin dielectric layers.

7. The organic substrate of claim 6, wherein said at least one thermally conductive metal member comprises a thick pad.

8. The organic substrate of claim 7, wherein said pad comprises copper, aluminum or alloys thereof.

9. The organic substrate of claim 1, wherein said integral organic substrate is thin.

10. The organic substrate of claim 1, wherein said plurality of openings within said thin dielectric layers are a combination of openings having diameter dimensions different from one another.

11. A method of making an organic substrate, said method comprising:
providing a plurality of thin dielectric layers;
forming a plurality of openings within each of said thin dielectric layers;
aligning said plurality of thin dielectric layers relative to one another such that said openings of each of said thin dielectric layers align relative to one another;
bonding said plurality of thin dielectric layers together to form an integral substrate structure having first and second opposing sides, wherein said openings define a plurality of common, linear parallel openings extending substantially entirely through said integral substrate structure from said first opposing side to said second opposing side; and
positioning a quantity of thermally conductive material within each of said common, parallel linear openings such that said quantity of thermally conductive material extends substantially entirely through said integral substrate structure from said first opposing side to said second opposing side, said integral substrate structure adapted for having at least one electrical component having a housing and thermal coupling means positioned on said housing positioned on said first opposing side and a cooling structure positioned on said second opposing side, said quantity of thermally conductive material providing a plurality of heat paths but not electrical paths through said integral substrate structure from said thermal coupling means on said housing of said at least one electrical component to said cooling structure to assist in providing effective cooling of said at least one electrical component during operation thereof.

12. The method of claim 11, wherein said forming of said plurality of openings is accomplished by mechanical or laser drilling.

13. The method of claim 11, wherein said bonding of said plurality of thin dielectric layers together is accomplished using lamination.

14. The method of claim 11, wherein said positioning of said quantity of thermally conductive material is accomplished by plating selected ones of said common, parallel linear openings and depositing a quantity of conductive paste within others of said common, parallel linear openings than said selected ones of said common, parallel linear openings.

15. The method of claim 11, further including forming a thermally conductive pad on at least one of said thin dielectric layers extending within one of said openings said thermally conductive pad comprising metal.

16. An electrical assembly comprising:
an organic substrate including a plurality of thin dielectric layers bonded together to form an integral substrate structure having first and second opposing sides, each of said thin dielectric layers including a plurality of openings therein, each of said pluralities of openings being aligned relative to one another to define a plurality of common, parallel linear openings extending substantially entirely through said integral substrate structure from said first opposing side to said second opposing side and a quantity of electrically and thermally conductive material within each of said common, parallel linear openings, said quantity of electrically and thermally conductive material extending substantially entirely through said integral substrate structure from said first opposing side to said second opposing side;
at least one electrical component having a housing with thermal coupling means thereon positioned on said first opposing side of said organic substrate relative to said common, linear openings; and
a cooling structure positioned on said second opposing side of said organic substrate relative to said common, linear openings, said quantity of thermally conductive material within said common, parallel linear openings providing a plurality of heat paths but not electrical paths through said integral substrate structure from said thermal coupling means on said housing of said at least one electrical component to said cooling structure to assist in providing effective cooling of said at least one electrical component during operation thereof.

17. The electrical assembly of claim 16, wherein said organic substrate is thin.

18. A method of making an organic substrate, said method comprising:
providing a first thin dielectric layer;
forming a plurality of openings within said first thin dielectric layer;
positioning a quantity of thermally conductive material within each of said openings;
aligning second and third thin dielectric layers on opposite sides of said first thin dielectric layer;
bonding said first, second and third thin dielectric layers together to form an integral substrate structure;
forming a plurality of openings within said second and third thin dielectric layers relative to said openings within said first thin dielectric layer to define a plurality of common, linear parallel openings extending substantially entirely through said integral substrate structure;
positioning a quantity of thermally conductive material within each of said openings within said second and third dielectric layers such that said quantities of thermally conductive material extends substantially entirely through said integral substrate structure, said integral substrate structure adapted for having at least one electrical component having a housing and thermal coupling means positioned on said housing positioned on said second thin dielectric layer and a cooling structure positioned on said third thin dielectric layer, said quantities of thermally conductive material providing a plurality of heat paths but not electrical paths through said integral substrate structure from said thermal coupling means on said housing of said at least one electrical component to said cooling structure to assist in providing effective cooling of said at least one electrical component during operation thereof.

19. The method of claim 18, wherein said forming of said plurality of openings within said first, second and third thin dielectric layers is accomplished by at least one of the group: mechanical and laser drilling.

20. The method of claim 18, wherein said bonding of said second and third thin dielectric layers to said first thin dielectric layer is accomplished using lamination.

21. The method of claim 18, wherein said positioning of said quantity of thermally conductive material of said first, second and third thin dielectric layers is accomplished by plating selected ones of said openings and then depositing a quantity of conductive paste within said selected ones of said openings.

22. The method of claim 18, further including forming a thermally conductive pad on at least one of said first, second and third thin dielectric layers said thermally conductive pad comprising metal, being part of said thermally conductive material within said selected ones of said openings.
